(19) United States
(12) Patent Application Publication
(10) Pub. No.: US 2001/0046022 A1
(43) Pub. Date: Nov. 29, 2001

(54) Tape carrier package with separated bonding parts, liquid crystal display employing the same and method of compensating misalignment thereof

(76) Inventors: Sung Woong Moon, Kyungsangbuk-do (KR); Sai Chang Yun, Kyungsangbuk-do (KR)

Correspondence Address: LONG ALDRIDGE, & NORMAN LLP, Sixth Floor, Suite 600, 701 Pennsylvania Avenue, N.W., Washington, DC, 20004, US

(21) Appl. No.: 09/863,399

(22) Filed: May 24, 2001

(30) Foreign Application Priority Data
May 24, 2000 (KR) 2000-28072

(51) Int. Cl. G02F 1/1345

(52) U.S. Cl. 349/150; 249/58

(57) ABSTRACT

A tape carrier package with separate bonding parts that is capable of reducing a thermal expansion of the bonding parts. In the tape carrier package, a pad part is provided with a plurality of pads bonded to pads of a liquid crystal display panel and is divided into at least two parts.

### BACKGROUND OF THE INVENTION

1. Field of the Invention

This invention relates to an apparatus for mounting an integrated circuit on a liquid crystal display, and more particularly to a tape carrier package with separated bonding parts that is capable of reducing a thermal expansion of the bonding parts. Also, the invention is directed to a liquid crystal display and a misalignment compensating method thereof wherein said tape carrier package is used to compensate for a misalignment of the liquid crystal display.

2. Description of the Related Art

Generally, a liquid crystal display (LCD) of active matrix driving system uses thin film transistors (TFT's) as switching devices to display a natural moving picture. Since such a LCD can be made into a smaller device in size than the existent Brown tube, it has been widely used for a monitor for a personal computer or a notebook computer as well as an office automation equipment such as a copy machine, etc. and a portable equipment such as a cellular phone and a pager, etc.

The active matrix LCD displays a picture corresponding to video signals, such as television signals, on a pixel (or picture element) matrix having pixels arranged each intersection between gate lines and data lines. Each pixel includes a liquid crystal cell for controlling a transmitted light quantity in accordance with a voltage level of a data signal from a data line. The TFT is installed at an intersection between the gate line and the data line to switch a data signal to be transferred to the liquid crystal cell in response to a scanning signal (i.e., a gate pulse) from the gate line.

Such a LCD requires a number of driving integrated circuits, hereinafter referred to as “D-IC”, connected to the data lines and the gate lines to apply data signals and scanning signals to the data lines and the gate lines, respectively. The D-ICs are installed between the printed circuit board (PCB) and the liquid crystal display panel to apply the data signals and the scanning signals to the data lines and the gate lines of the liquid crystal panel in response to a control signal applied from the PCB. As a mounting method of the D-ICs has been generally used a tape automated bonding (TAB) system that is capable of widening an effective area of the panel and has a relatively simple mounting process.

The TAB system is divided into a bending type as shown in FIG. 1 and a flat type as shown in FIG. 2. The bending-type TAB system as shown in FIG. I has been used to mount source and gate drivers of a monitor or a notebook computer. In the bending-type TAB system, a PCB 6 is folded and bonded to the rear side of a liquid crystal panel 2 by bending a tape carrier package (TCP) 10 mounted with a D-IC 8 and connected between a lower glass substrate 3 of the liquid crystal panel 2 and the PCB 6.

The flat-type TAB system as shown in FIG. 2 has been almost not used for a notebook computer, but has been mainly employed as a source driver mounting method of a monitor. In the flat-type TAB system, a TCP 12 mounted with a D-IC 8 and connected between the lower glass substrate 3 and the PCB 6 is not bent to keep a plane state.

In FIG. 1 and FIG. 2, the front side of the upper glass substrate 1 of the LCD panel 2 is attached with a polarizer while the rear side thereof is provided with a color filter, a black matrix and an alignment film. The front side of the lower glass substrate 3 of the LCD panel 2 is provided with a TFT, a gate line, a gate pad, a data line, a data pad, a pixel electrode and an alignment film while the rear side thereof is attached with a polarizer. A backlight 4 is installed under the lower glass substrate 3 of the LCD panel 2 to irradiate a light onto the LCD panel 2.

As shown in FIG. 3, in the TCP 10 or 12, an output pad 16 is provided at the upper portion of a base film 20 while an input pad 14 is provided at the lower portion of the base film 20. The base film 20 is usually made from polyimide. The output pad 16 of the TCP 10 or 12 is connected to a pad of the gate line or the data line formed on the lower glass substrate 3 by means of an anisotropic conductive film (ACF) . The input pad 14 is connected to an output signal wire of the PCB 6.

When the D-IC 8 mounted in the TCP 10 or 12 is a gate D-IC, this gate D-IC plays a role to supply a video data to the data lines of the LCD panel 2 in response to a dot clock under control of a controller (not shown) . On the other hand, when the D-IC 8 mounted in the TCP 10 or 12 is a data D-IC, this data D-IC plays a role to sequentially apply a scanning pulse to the gate lines under control of the controller.

The conventional TAB system has a problem in that, when the TCP 10 or 12 is bonded onto the LCD panel 2, the bonding part of the TCP 10 or 12, that is, the output pad 16 is expanded due to a heat. More specifically, the TCP 10 or 12 is bonded to the edge of the lower glass substrate 3 with having the ACF therebetween under high-temperature and high-pressure circumstance. The output pad 16 of the TCP 10 or 12 is expanded due to a heat according to such high-temperature and high-pressure circumstance. Accordingly, since a space between pads 16a formed at the output pad 16 of the TCP 10 or 12 becomes different from a space between pads 3a formed on the lower glass substrate 3, an misalignment occurs when the TCP 10 or 12 is bonded onto the lower glass substrate 3. As a result, an electrical short may be generated between the adjacent pads 3a or 16a.

In order to reduce a misalignment caused by a thermal expansion of the TCP 10 or 12, the output pad 16 is designed by calculating a compensation amount a against a thermal expansion amount of the output pad 16 and then applying a length L which is a value subtracting the compensation amount a from the product of the pitch of pads by the number of pads. Herein, the compensation amount a is given by the following formula:

α=bonding temperature×pad length (L)×a thermal expansion coefficient of the film×a process compensation coefficient . . . (1)

wherein the thermal expansion coefficient of the film represents a thermal expansion coefficient of the base film 20.

As a resolution goes higher, the number of pads 3a and 16a becomes larger and the length of the output pad 16 becomes larger. Thus, a thermal expansion amount of the output pad 16 and the compensation amount a therefor are increased. However, since there is a limitation in increasing the compensating amount α against a thermal expansion coefficient of the output pad 16, a scheme capable of reducing a thermal expansion of the output pad 16 itself is required.

### SUMMARY OF THE INVENTION

Accordingly, it is an object of the present invention to provide a tape carrier package with separate bonding parts that is capable of reducing a thermal expansion of the bonding parts.

A further object of the present invention is to provide a liquid crystal display and a misalignment compensating method thereof wherein the above-mentioned tape carrier package is used to compensate the misalignment thereof.

In order to achieve these and other objects of the invention, a tape carrier package with separated bonding parts according to one aspect of the present invention includes a pad part being provided with a plurality of pads bonded to pads of the liquid crystal display panel and divided into at least two parts.

In the tape carrier package, the pad part is divided with having a desired width of slit therebetween. The slit is mounted with an integrated circuit and formed by removing one side of a base film provided with the pad part.

A liquid crystal display according to another aspect of the present invention includes a pad part being provided with a plurality of pads and divided into at least two parts; and a substrate provided with pads of a driving wire to which pads of the tape carrier package is bonded, said tape carrier package being bonded onto the substrate.

A method of compensating a misalignment between pads of a liquid crystal display panel according to still another aspect of the present invention includes the steps of dividing a pad part of a tape carrier package into at least two parts so as to reduce a thermal expansion occurring at the pad part of the tape carrier package upon bonding of the liquid crystal display panel to the tape carrier package; and bonding the tape carrier package having the divided pad parts onto a substrate of the liquid crystal display panel.

### BRIEF DESCRIPTION OF THE DRAWINGS

These and other objects of the invention will be apparent from the following detailed description of the embodiments of the present invention with reference to the accompanying drawings, in which:

FIG. 1 is a section view showing a conventional bending-type tape automated bonding (TAB) method;

FIG. 2 is a section view showing a conventional flat-type TAB method;

FIG. 3 is a section view showing a structure of the tape carrier package shown in FIG. 1 and FIG. 2;

FIG. 4 is a plan view showing a misalignment between pads on the lower glass substrates and pads on the tape carrier package;

FIG. 5 is a section view showing a structure of a tape carrier package according to an embodiment of the present invention;

FIG. 6 is a perspective view showing a bending-type TAB system according to the present invention;

FIG. 7 is a perspective view showing a flat-type TAB system according to the present invention; and

FIG. 8 is a plan view showing an alignment between pads on the lower substrate and pads on the tape carrier package according to the present invention.

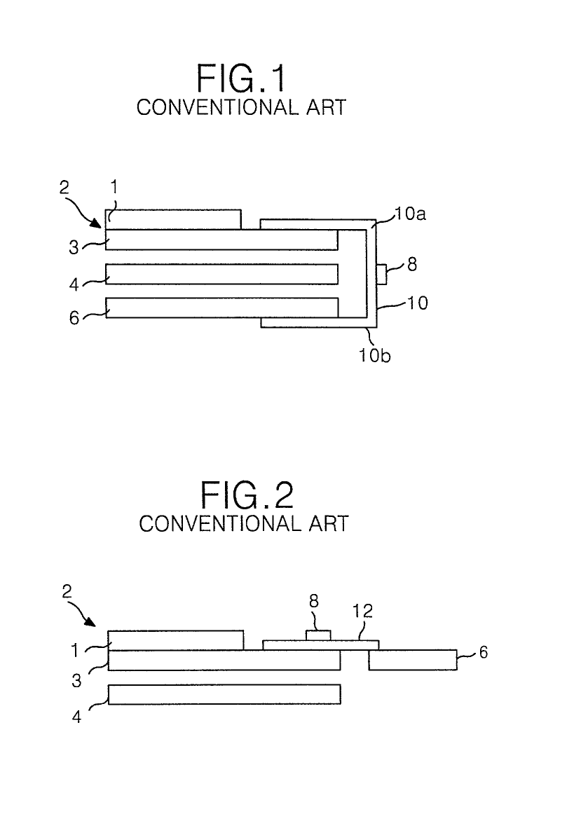

### DETAILED DESCRIPTION OF THE PREFERRED EMBODIMENT

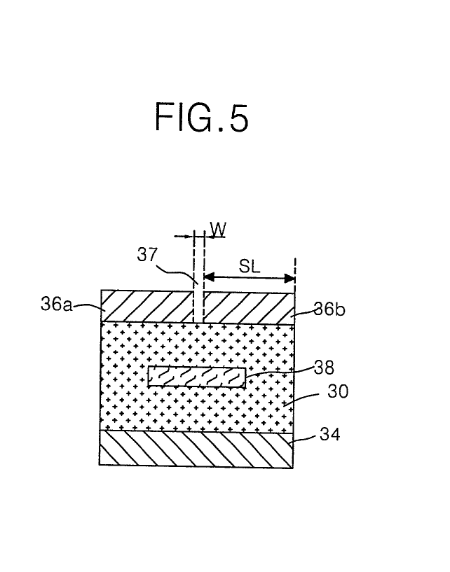

Referring to FIG. 5, there is shown a tape carrier package (TCP) with separated bonding parts according to an embodiment of the present invention. The TCP with separated bonding parts includes first and second output pads 36a and 36b separated with having a slit 37 therebetween at the upper portion of a base film 30, an input pad 34 positioned at the lower portion of the base film 30, and a D-IC 38 mounted at the center of the base film 30.

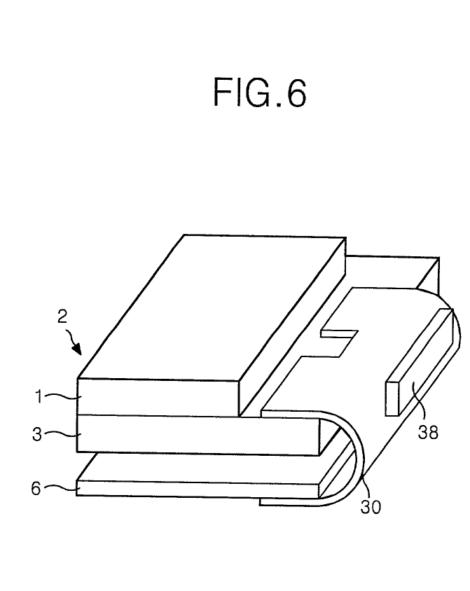

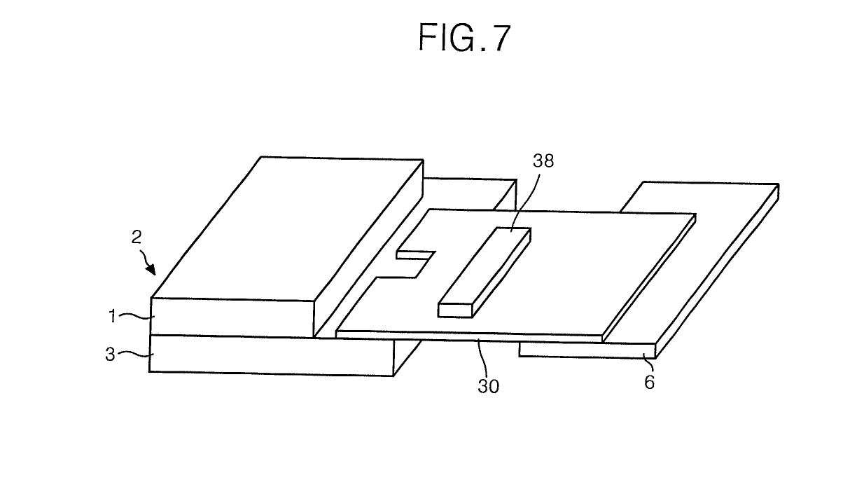

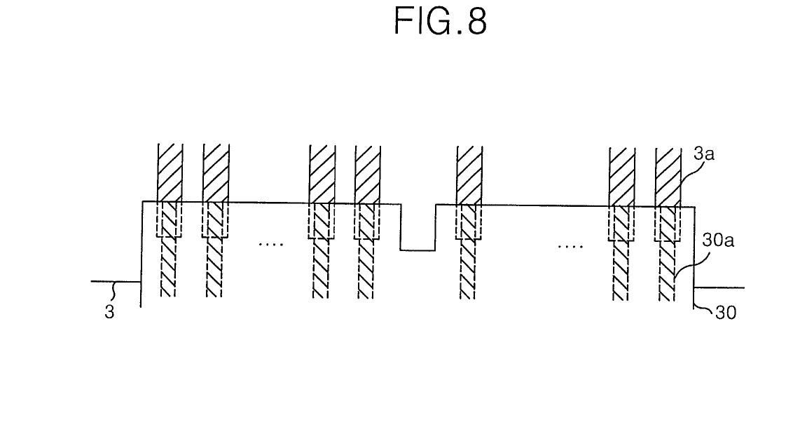

A number of pads are provided at the first and second output pads 36a and 36b and the input pad 34. The input and output pads of the TCP are extended from a lead wire on the base film 30 connected to pins of the D-IC 38. As shown in FIG. 6 and FIG. 7, the first and second output pads 36a and 36b is connected to a pad of a gate line or a data line provided on a lower glass substrate 3. The input pad 34 is connected to an output signal wire of a PCB 6. The present TCP can be bonded onto a LCD panel in such a manner to have a bending type as shown in FIG. 6 or a flat type as shown in FIG. 7. In FIG. 6 and FIG. 7, the front side of an upper glass substrate 1 of the LCD panel 2 is attached with a polarizer while the rear side thereof is provided with a color filter, a black matrix and an alignment film. The front side of the lower glass substrate 3 of the LCD panel 2 is provided with a TFT, a gate line, a gate pad, a data line, a data pad, a pixel electrode and an alignment film while the rear side thereof is attached with a polarizer. A backlight 4 is installed under the lower glass substrate 3 of the LCD panel 2 to irradiate a light onto the LCD panel 2.

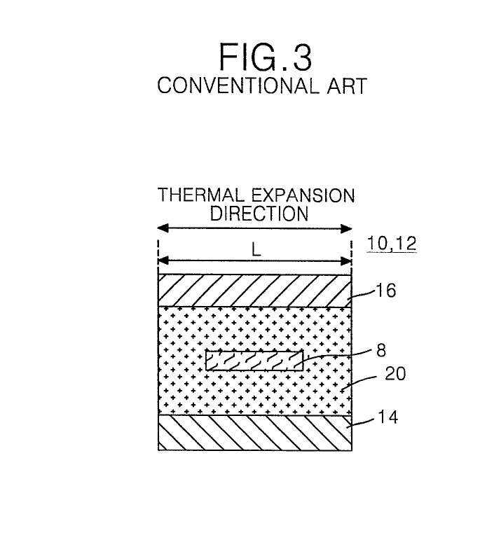

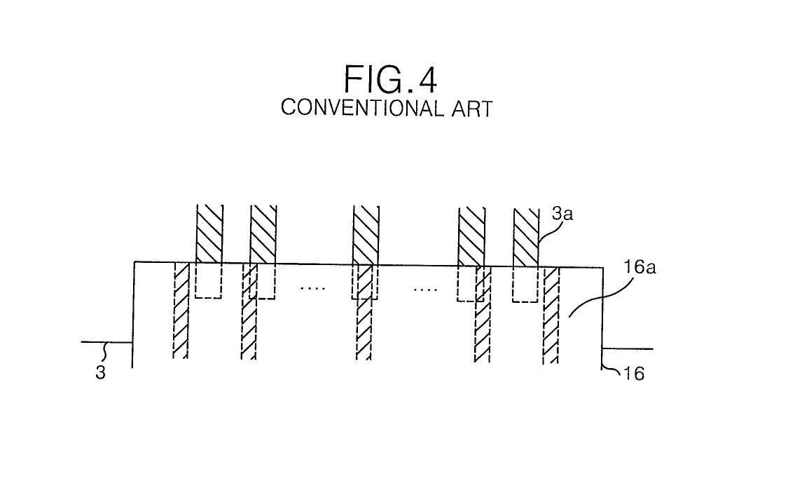

Since the first and second output pads 36a and 36b are separated from each other with having a slit 37 therebetween, a length SL of each pad is more reduced than a length L of the conventional output pad 16, as shown in FIG. 3, which is not provided with the slit 37. The slit 37 is formed on the TCP by cutting and removing the center of the upper portion of the base film 30.

Hereinafter, a process of bonding the TCP onto the LCD panel 2 will be described.

First, the ACF is coated onto the pad formed at the lower glass substrate 3 of the LCD panel 2 or onto the bonded surface of the first and second output pads 36a and 36b of the TCP. A heat is applied to the bonded portion of the lower glass substrate 3 onto which the TCP is bonded, to thereby bond the TCP onto the lower glass substrate 3. At this time, although the first and second output pads 36a and 36b are thermally expanded, the thermal expansion amount is reduced by such an amount that the length SL of each pad is reduced as can be seen from the above formula (1). As a result, a misalignment is not generated between the pads 3a and 3oa on the TCP and the lower glass substrate 3, so that the pads 3a and 30a on the TCP and the lower glass substrate 3 are bonded in such a manner to accurately correspond to a relationship of one to one.

It is desirable that a width W of the slit 37 dividing the output pads 36a and 36b should be designed to have a minimum value in consideration of a thermal expansion compensation amount α of the output pads 36a and 36b. Assuming that n is the number of slits 37, that is, the divided number, the length SL of each of the output pads 36a and 36b is reduced by (n+1) times. Likewise, the compensation amount α also is reduced by (n+1) times such as corresponds to a reduced extent of the length SL of each output pad 36a and 36B in the above formula (1). As described above, according to the present invention, the output pad of the TCP is multi-divided to reduce the length of each output pad, thereby reducing a thermal expansion of the TCP bonding part generated upon bonding of the TCP. Furthermore, the D-ICs are mounted onto the LCD panel using the TCP with separated bonding parts, so that it becomes possible to prevent a misalignment between the output pads of the TCP and the pads formed on the glass substrate of the LCD panel caused by a thermal expansion of the TCP occurring upon bonding of the TCP.

Although the present invention has been explained by the embodiments shown in the drawings described above, it should be understood to the ordinary skilled person in the art that the invention is not limited to the embodiments, but rather that various changes or modifications thereof are possible without departing from the spirit of the invention. Accordingly, the scope of the invention shall be determined only by the appended claims and their equivalents.

What is claimed is:

1. A tape carrier package that is bonded onto a liquid crystal display panel, comprising:
a pad part being provided with a plurality of pads bonded to pads of the liquid crystal display panel and divided into at least two parts.

2. The tape carrier package according to claim 1, wherein the pad part is divided with having a desired width of slit therebetween.

3. The tape carrier package according to claim 2, wherein the slit is mounted with an integrated circuit and formed by removing one side of a base film provided with the pad part.

4. The tape carrier package according to claim 1, wherein the slit is positioned at the center of the upper portion of the base film opposed to the pads of the liquid crystal display panel.

5. The tape carrier package according to claim 1, further comprising:
a printed circuit board mounted with circuits generating driving signals for driving the liquid crystal display panel, wherein
said tape carrier package is bonded in a bent state between the liquid crystal display panel and the printed circuit board.

6. The tape carrier package according to claim 1, further comprising:
a printed circuit board mounted with circuits generating driving signals for driving the liquid crystal display panel, wherein
an output pad of the tape carrier package is bonded in a plane state between the liquid crystal display panel and the printed circuit board.

7. A liquid crystal display wherein a tape carrier package is bonded onto a liquid crystal display panel, comprising:
a pad part being provided with a plurality of pads and divided into at least two parts; and
a substrate provided with pads of a driving wire to which pads of the tape carrier package is bonded, said tape carrier package being bonded onto the substrate.

8. The liquid crystal display according to claim 7, wherein the pad part is divided with having a desired width of slit therebetween.

9. The liquid crystal display according to claim 7, further comprising:
a printed circuit board mounted with circuits generating driving signals for driving the liquid crystal display panel and to which an input pad of the tape carrier package is connected.

10. The liquid crystal display according to claim 7, further comprising:
a backlight unit being installed under the substrate to irradiate a light onto the liquid crystal display panel.

11. A method of compensating a misalignment between pads of a liquid crystal display panel to which a tape carrier package is bonded, said method comprising the steps of:
dividing a pad part of the tape carrier package into at least two parts so as to reduce a thermal expansion occurring at the pad part of the tape carrier package upon bonding of the liquid crystal display panel to the tape carrier package; and
bonding the tape carrier package having the divided pad parts onto a substrate of the liquid crystal display panel.
